(19) United States
(12) Patent Application Publication
(10) Pub. No.: US 2011/0139859 A1
(43) Pub. Date: Jun. 16, 2011

(54) METHOD FOR REMOVING BRAZING RESIDUES FROM ALUMINUM ARTICLES

(75) Inventors: Mark R. Jaworowski, Glastonbury, CT (US); Jack Leon Esformes, Jamesville, NY (US); Neal Magdefrau, Tolland, CT (US); Michael F. Taras, Fayetteville, NY (US)

(73) Assignee: CARRIER CORPORATION, Farmington, CT (US)

(21) Appl. No.: 13/059,786

(22) PCT Filed: May 1, 2009
(86) PCT No.: PCT/US09/42552

§ 371 Date: Feb. 18, 2011

Related U.S. Application Data
(60) Provisional application No. 61/089,585, filed on Aug. 18, 2008.

(51) Int. Cl. B23K 31/02; B23K 1/20

(52) U.S. Cl. 228/176; 228/199

(57) ABSTRACT

In a method of preparing an aluminum surface, flux is applied to the aluminum surface and the aluminum surface is brazed. Residual flux and metal oxides are removed from the aluminum surface using an aqueous fluid having a pH between about 5 and about 9.

### CROSS-REFERENCE TO RELATED APPLICATION

This application claims priority from U.S. Provisional Application Ser. No. 60/089,585, filed Aug. 18, 2008.

### BACKGROUND

Aluminum and aluminum alloys (hereinafter referred to as aluminum) are known and used in heat exchangers for their relatively high strength and formability. For instance, manifolds, fins, and/or tubes of heat exchangers may be made from aluminum. However, aluminum can corrode under normal atmospheric conditions. Therefore, a protective coating or paint is often applied to the aluminum to resist corrosion of the underlying aluminum.

One drawback of using protective coatings and paints is that manufacturing processes used to form aluminum into a component may not be compatible with forming a strong bond between the aluminum and the coatings. For instance, in the manufacture of heat exchangers, a brazing process may be used to bond aluminum fins, tubes and manifolds together using brazing material and a flux material. Commonly used flux materials can leave a residual oxide glazing on surfaces of the tubes and the fins, which may inhibit bonding between a coating or paint and the aluminum. Conventional chemical treatments (acid or base etches) are sometimes used to prepare the surfaces of the aluminum for bonding with the coating. However, the chemical reagents used in those treatments are typically intended to react with the aluminum or corrosion products and are ineffective for removing the oxide glazing. The chemical reagents can also leave behind residues themselves that inhibit bonding between the coatings and the underlying aluminum.

### SUMMARY

In a method of preparing an aluminum surface, flux is applied to the aluminum surface and the aluminum surface is brazed. Residual flux and metal oxides are removed from the aluminum surface using an aqueous fluid having a pH between about 5 and about 9.

### BRIEF DESCRIPTION OF THE DRAWINGS

FIG. 1 is a front view of one embodiment of a brazed aluminum article.

FIG. 2 is an exploded view of an example of a brazed joint with brazing residues.

FIG. 3 is a flow diagram illustrating one embodiment of brazing residue removal.

FIG. 4 is a view of the brazed joint of FIG. 2 following brazing residue removal.

### DETAILED DESCRIPTION

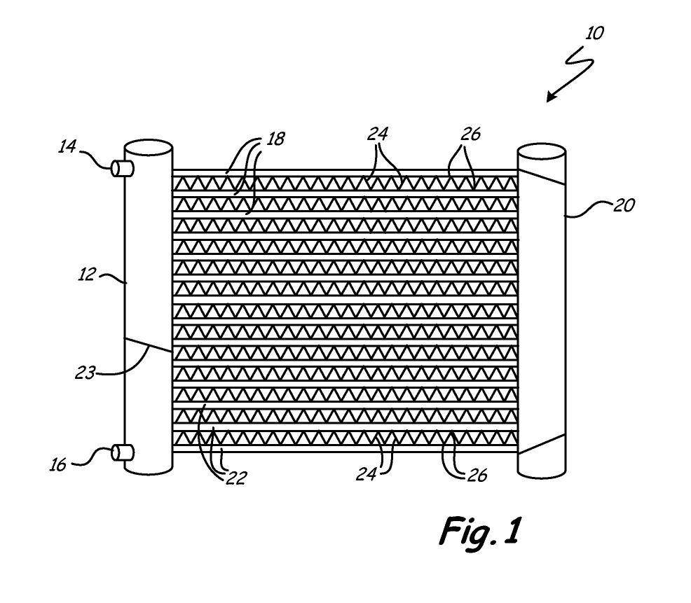

FIG. 1 illustrates parts of one embodiment of brazed aluminum article 10. Brazed aluminum article 10 can be aluminum or an aluminum alloy. Within this disclosure, “aluminum” shall refer to both aluminum and aluminum alloys. In this example, brazed aluminum article 10 is a heat exchanger. However, it is to be understood that this disclosure is also applicable to other types of brazed aluminum articles and is not limited to heat exchangers or the type of heat exchanger shown. While FIG. 1 illustrates a straight (planar) heat exchanger, formed heat exchangers and parts can also benefit from the method of the invention.

Brazed aluminum article (heat exchanger) 10 includes first manifold 12 having inlet 14 for receiving a working fluid, such as coolant, and outlet 16 for discharging the working fluid. First manifold 12 is fluidly connected to each of a plurality of tubes 18 that are each fluidly connected on an opposite end with second manifold 20. Second manifold 20 is fluidly connected with each of a plurality of tubes 22 that return the working fluid to first manifold 12 for discharge through outlet 16. Partition 23 is located within first manifold 12 to separate inlet and outlet sections of first manifold 12. Tubes 18 and 22 can include channels, such as microchannels, for conveying the working fluid. The two-pass working fluid flow configuration described above is only one of many possible design arrangements. Single and other multi-pass fluid flow configurations can be obtained by placing partitions 23, inlet 14 and outlet 16 at specific locations within first manifold 12 and second manifold 20. The method of the invention is applicable to brazed aluminum articles regardless of their fluid flow configuration.

Fins 24 extend between tubes 18 and the tubes 22 as shown in FIG. 1. Fins 24 support tubes 18 and 22 and establish open flow channels between the tubes 18 and 22 (e.g., for airflow) to provide additional heat transfer surfaces. Fins 24 also provide support to the heat exchanger structure. Fins 24 are bonded to tubes 18 and 22 at brazed joints 26. Fins 24 are not limited to the triangular cross-sections shown in FIG. 1. Other fin configurations (e.g., rectangular, trapezoidal, oval, sinusoidal) are suitable.

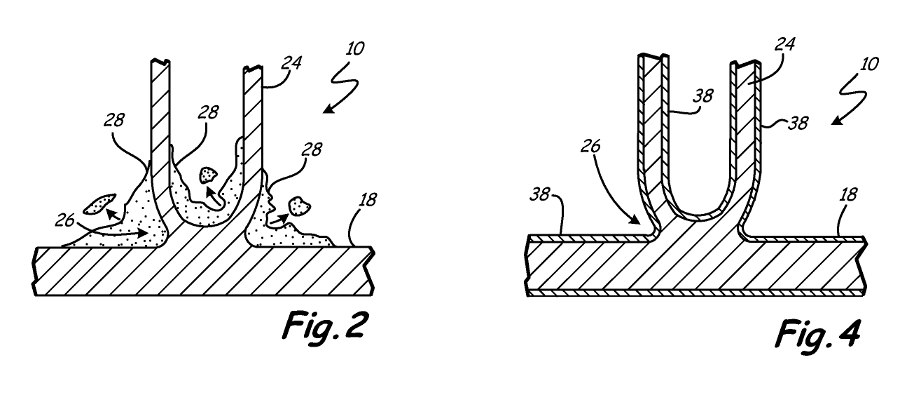

FIG. 2 illustrates one embodiment of a brazed joint 26 of brazed aluminum article 10. In this embodiment, brazed joint 26 is formed between tube 18 and fin 24 in a brazing process using a flux material. Although not shown in FIG. 2, a brazed joint 26 is also formed between tube 22 and fin 24 in a similar manner. In one embodiment, the flux material includes at least potassium, aluminum and fluorine. The fluorine can comprise at least a majority of the flux material by weight. One such flux material is Nocolok®, available from Solvay Fluor GmbH. The braze process can be a “controlled atmosphere braze” process conducted under a substantially pure nitrogen atmosphere. At a predetermined brazing temperature, the flux material interacts with a braze material, typically provided as a cladding material on fins 24 to melt the cladding material. The melted cladding material flows between fin 24 and tube 18 or 22 and forms a strong bond upon cooling and solidification.

The flux material from the brazing process can leave a residual fluoro-compound 28 on portions of the surfaces of fins 24 and tubes 18, 22. Fluoro-compound residue 28 can include fluorine from the flux material in combination with other elements from the atmosphere, flux, cladding or from the aluminum of tubes 18, 22 or fins 24. For instance, fluoro-compound residue 28 can include phases of fluoride and/or fluoro-oxy-compounds. Thus, the composition of fluoro-compound residue 28 can vary depending on the composition of the flux material, composition of the aluminum, atmosphere, and brazing process and conditions.

If fluoro-compound residue 28 is not removed from the surfaces of fins 24 and tubes 18, 22, fluoro-compound residue 28 can inhibit strong bonding between a later deposited protective coating or paint and the underlying aluminum of fins 24 and tubes 18, 22. Fluoro-compound residue 28 can also contribute to formation of a powdery corrosion product on surfaces of brazed aluminum article 10 that can inhibit bonding between a later deposited protective coating or paint, or produce an undesired visual appearance.

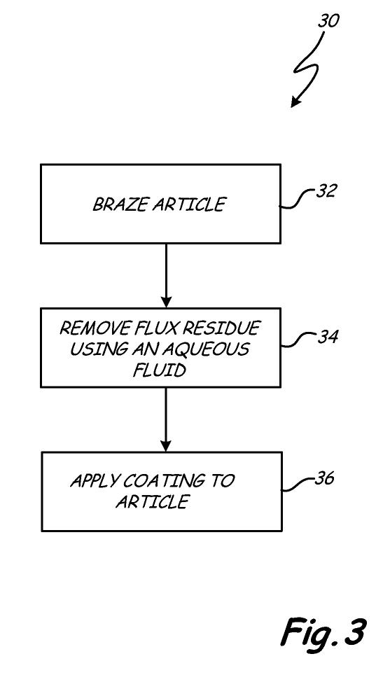

Method 30 illustrated in FIG. 3 is one embodiment of a method that can be used to clean brazed joint 26 of brazed aluminum article 10 and thereby remove fluoro-compound residue 28. Method 30 includes brazing an aluminum article (step 32), removing flux residue from the aluminum article using primarily water (step 34) and an optional step of coating the aluminum article (step 36). Brazing step 32 is as described above in reference to FIG. 2 where a flux material and a cladding material are used to braze together aluminum articles, such as fins 24 and tubes 18, 22. Flux residue removal step 34 includes exposing brazed joint 26 of brazed aluminum article 10 to an aqueous fluid having a pH between about 5 and about 9, at a predetermined temperature for a predetermined amount of time. At step 34, fluoro-compound residue 28 is removed from brazed joint 26 using the aqueous fluid to thereby clean brazed joint 26. Step 34 can be accomplished by various methods which are described in detail below.

The aqueous fluid used in step 34 can be a liquid or a gas. Suitable aqueous fluids include water and steam. When the aqueous fluid is water or steam, the water or steam is substantially pure in order to limit chemical interactions between the aqueous fluid and brazed aluminum article 10. For instance, the water or steam flows around and through pores of fluoro-compound residue 28 with limited chemical interaction. The water at the predetermined temperature causes internal stress within fluoro-compound residue 28 by physical processes, such as hydration and thermal expansion, which serves to break apart fluoro-compound residue 28 and remove fluoro-compound residue 28 from the surface of brazed aluminum article 10. Thus, the water is able to penetrate fluoro-compound residue 28 and facilitate mechanical removal. Impure water or impurities within impure water can react with fluoro-compound residue 28. Such reaction products can inhibit removal or leave residual byproducts that inhibit strong bonding between brazed aluminum article 10 and a later applied coating.

Substantially pure water is water free of contaminants that could react undesirably with fluoro-compound residue 28. For example, pH is an indicator of the purity of the water. Substantially pure water generally has a pH between about 5 and about 9. Particularly suitable substantially pure water has a pH between about 6 and about 8. In another example, electrical conductivity is an indicator of the purity of the water. Substantially pure water has an electrical conductivity less than about 400 microsiemens per centimeter. Particularly suitable substantially pure water has an electrical conductivity less than about 50 microsiemens per centimeter. If the water is not substantially pure, the water may not effectively infiltrate fluoro-compound residue 28 for mechanical removal. In some examples, water of the given pH or electrical conductivity can be deionized water or water purified using a reverse osmosis process.

Suitable aqueous fluids also include aqueous solutions containing small amounts of a surfactant, an electrolyte, a cosolvent, a buffer and combinations thereof. As above, the water present in aqueous solutions is substantially pure in order to limit undesirable chemical interactions between the aqueous solutions and brazed aluminum article 10. When present, surfactants, electrolytes and cosolvents provide useful cleaning properties to the aqueous solutions and can enhance removal of fluoro-compound residue 28. Buffers can also be added to aqueous solutions to maintain the pH of the aqueous solution between about 5 and about 9 to prevent undesirable chemical interactions. Suitable examples of surfactants, electrolytes, cosolvents and buffers are described below along with the particular embodiments in which they are used.

In one embodiment, step 34 includes immersing brazed aluminum article 10 in water. Brazed aluminum article 10 is immersed in substantially pure water at a predetermined temperature for a predetermined period of time to remove fluoro-compound residue 28. The amount of time can depend upon the temperature of the water or brazed aluminum article 10. At higher temperatures, less time may be needed and at lower temperatures, more time may be needed. For example, at a water temperature between about 82° C. and the boiling point of water (100° C.), the predetermined time can be up to about two hours to remove fluoro-compound residue 28. In another example, for a water temperature around 60° C., the predetermined time can be up to about twelve to fourteen hours. At approximately room temperature (20 to 23.5° C.), a time on the order of up to about eight to ten days can be required to remove fluoro-compound residue 28 Immersion can limit the introduction of atmospheric gases, such as oxygen, that can lead to formation of oxides on surfaces of brazed aluminum article 10. Where oxidation is a concern, brazed aluminum article 10 can be immersed in deoxygenated water.

In another embodiment, step 34 includes spraying brazed aluminum article 10 with water. Brazed aluminum article 10 is sprayed with substantially pure water at a predetermined temperature for a predetermined period of time to remove fluoro-compound residue 28. As with immersion, the amount of time can depend upon the temperature of the water or brazed aluminum article 10. The water can be heated before it is sprayed onto brazed aluminum article 10 or brazed aluminum article 10 can be heated to an elevated temperature and room temperature water is sprayed onto brazed aluminum article 10. At higher temperatures, less time may be needed and at lower temperatures, more time may be needed. For example, for a temperature (water or article temperature) above about 80° C., the predetermined time can be up to about two hours to remove fluoro-compound residue 28.

In another embodiment, step 34 includes directing steam (gaseous water) at brazed aluminum article 10 rather than liquid water. The relatively high temperature of steam can effectively and rapidly remove fluoro-compound residue 28 from brazed aluminum article 10. Directing steam at pressures above ambient pressure at brazed aluminum article 10 is effective at removing heavy deposits of fluoro-compound residue 28. Heavy deposits of fluoro-compound residue 28 can occur in areas of brazed aluminum article 10 where brazing is prevalent, such as manifold regions or the periphery of heat exchangers. In one example, steam is directed at brazed aluminum article 10 at pressures between about 100 psi and about 1000 psi for times between about five minutes and about thirty minutes. In some cases, immersion can be better suited for fully exposing all surfaces of brazed aluminum article 10 to the water for removal of fluoro-compound residue 28. Steam treatment can be combined with hot water immersion or spraying as described above for improved flux residue removal. The steam and spraying treatments can be performed on all sides of brazed aluminum article 10.

In another embodiment, step 34 includes agitating the water once brazed aluminum article 10 is immersed in the water. Agitation can be provided by mixing or ultrasonic vibration. In one example, ultrasonic vibration (sonication) is applied to immersion water at a temperature between about room temperature (20° C. to 23.5° C.) and about 90° C. for about five minutes to about thirty minutes. The immersion water can be degassed prior to sonication by preheating, sparging or other means. Power is applied at a frequency between about 15 kHz and about 400 kHz at a density between about 2.6 watts per liter (10 watts per gallon) and about 26.4 watts per liter (100 watts per gallon). More preferably, sonication is performed at a temperature between about 50° C. and about 66° C. for about ten to twenty minutes with a power density between about 5.3 watts per liter (20 watts per gallon) and about 7.9 watts per liter (30 watts per gallon) at a frequency between about 25 kHz and about 50 kHz. Ultrasonic cleaning can also be combined with separate immersion, spray or steam treatments as described above. In one example, ultrasonic cleaning for between about five minutes and about thirty minutes followed immersion in hot water (between about 85° C. and about 100° C.) without sonication for between about five minutes and about thirty minutes removes fluoro-compound residue 28 from brazed aluminum article 10 quickly.

Some embodiments of flux residue removal step 34 include the addition of small amounts of optional additives to substantially pure water to form aqueous solutions. These additives offer the potential for additional flux removal without significantly increasing chemical reactions with brazed aluminum article 10.

In one embodiment, step 34 includes electrocleaning brazed aluminum article 10. Electrocleaning is a cleaning process used for metal surfaces employing direct current and water generally containing an electrolyte. Brazed aluminum article 10 serves as an anode, a cathode or both, in an electrocleaning cell depending on the application. Electrocleaning provides for mechanical removal and conditioning or modification of fluoro-compound residue 28 so that it is easier to remove from surfaces of brazed aluminum article 10. As current is applied to an electrocleaning cell, electrochemical reactions take place, electrolyzing water; the electrolyte serves as a conductive medium. The following reaction takes place at the anode:

2H₂O→4H⁺+O₂+4e⁻,

and the following reaction takes place at the cathode:

4H₂O+4e⁻→4OH⁺+2H₂.

The gases generated at the anode and cathode (oxygen and hydrogen) create a mechanical scrubbing action that loosens and lifts soils, such as fluoro-compound residue 28. When brazed aluminum article 10 serves as the anode, anodic electrocleaning occurs. When brazed aluminum article 10 serves as the cathode, cathodic electrocleaning takes place. In reverse electrocleaning, the polarity of the electrocleaning cell changes so that both anodic and cathodic electrocleaning occurs. When the final electrocleaning cycle is anodic, any charged particles that may have plated onto brazed aluminum article 10 during cathodic electrocleaning are removed. Electrolysis is the driving process in electrocleaning. The amount of gassing at the electrodes for scrubbing action is related to the amount of current passing through the electrocleaning cell.

In one example of step 34 using electrocleaning, brazed aluminum article 10 is pre-soaked in or treated with hot water to hydrate fluoro-compound residue 28. Brazed aluminum article 10 serves as the cathode (cathodic electrocleaning) in the electrocleaning cell. Since hydrogen is generated at the cathode rather than oxygen (generated at the anode), brazed aluminum article 10 is less likely to experience oxidation. The hydroxide produced at the cathode also neutralizes any acidity beneath fluoro-compound residue 28. Reverse anodic current for about five to fifteen seconds at the end of the electrocleaning cycle also eliminates any positively-charged particles near or on brazed aluminum article 10. Total electrocleaning time will vary depending on the amount of flux contamination. Cleaning times ranging from about thirty seconds to about five minutes are generally suitable. Voltage applied to the electrocleaning cell generally ranges between about six volts and about twelve volts at a current density between about 50 amperes per square meter (five amperes per square foot) and about 165 amperes per square meter (fifteen amperes per square foot) to prevent “burning” brazed aluminum article 10. The water temperature is between about 50° C. and about 80° C. Electrolytes can be added to the water to increase the efficacy of the electrocleaning process. Suitable electrolytes include sodium carbonate, sodium orthosilicate, sodium gluconate, trisodium phosphate and combinations thereof. Electrolytes can be added to the water in amounts between about 2 mL and about 40 mL of individual or total electrolyte per liter of water.

In another embodiment, step 34 includes adding a surfactant or cosolvent to the water. Surfactants facilitate infiltration of the water into fluoro-compound residue 28. The surfactant can be present in relatively small amounts, but is not limited to any particular composition. The surfactant can be anionic, cationic, nonionic or zwitterionic, depending upon the particular chemistry of the flux material and fluoro-compound residue 28. One suitable surfactant is sodium lauryl sulfate. In one embodiment in which a surfactant is added to the water, step 34 also includes agitation using mixing or ultrasonic vibration once brazed aluminum article 10 is immersed in the water. Suitable ultrasonic vibration conditions include those listed above. A cosolvent can also be used in conjunction with ultrasonic vibration. Suitable cosolvents include isopropyl alcohol.

Optional coating step 36 can follow flux residue removal step 34 to apply a protective coating or paint to brazed aluminum article 10. FIG. 4 illustrates brazed joint 26 from FIG. 2 after removal of fluoro-compound residue 28. The substantially pure water has substantially or entirely cleaned fluoro-compound residue 28 from brazed joint 26. In the illustrated example, fluoro-compound residue 28 has been completely removed from brazed joint 26, and coating 38 has been subsequently deposited on surfaces of brazed aluminum article 10.

Coating 38 can be a conversion coating and/or a polymeric material, such as paint. In one example, coating 38 is a trivalent chromium conversion coating, which can be a stand alone coating or a primer coating for subsequent coatings. Coating 38 can be a phosphate conversion coating containing iron, manganese or zinc. Coating 38 can also include an anodic coating and paint.

Prior surface treatment processes to prepare aluminum for coatings focused on removing aluminum oxides using acidic or basic reagents unsuitable for removing fluoro-compound residue 28. However, method 30 utilizes water that is substantially pure and able to infiltrate and remove fluoro-compound residue 28 in preparation for depositing coating 38. Thus, the surfaces of the underlying aluminum of brazed aluminum article 10 are clean and capable of forming a strong bond with coating 38. Furthermore, if coating 38 is not applied, removal of fluoro-compound residue 28 using method 30 can limit formation of powdery materials having an undesirable visual appearance.

Exposing brazed aluminum article 10 to the aqueous fluid as in method 30 can be conducted as part of a manufacturing process of brazed aluminum article 10, or as a “repair” once brazed aluminum article 10 is in field use. For instance, method 30 can be implemented immediately subsequent to a brazing process to remove fluoro-compound residue 28, or just prior to forming coating 38 on brazed aluminum article 10 to provide a clean surface capable of forming a strong bond. Alternatively, method 30 can be implemented after brazed aluminum article 10 has been installed at a field site as “a repair,” or to provide a countermeasure for the appearance of a powdery material in the field.

The present invention provides for a method of removing residual brazing flux and metal oxides from an aluminum article. Following application of flux and brazing, a fluid removes residual flux by way of immersion, spraying, steaming, sonication or electrocleaning. The fluid can be water or water with a surfactant or electrolyte additive. The flux residue removal method provides for efficient and cost-effective removal of residual flux to improve bonding between the aluminum article and later applied coatings or to improve visual appearance.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A method comprising:
applying flux to an aluminum surface;
brazing the aluminum surface; and
removing residual flux and metal oxides from the aluminum surface using an aqueous fluid having a pH between about 5 and about 9.

2. The method of claim 1, wherein the aqueous fluid is at a temperature between about 20° C. and about 100° C.

3. The method of claim 1, wherein the aqueous fluid has a pH between about 6 and about 8.

4. The method of claim 1, wherein the aluminum surface is exposed to the aqueous fluid for between about five minutes and about fourteen hours.

5. The method of claim 4, wherein the aluminum surface is exposed to the aqueous fluid for between about five minutes and about two hours.

6. The method of claim 5, wherein the aluminum surface is exposed to the aqueous fluid for between about five minutes and about forty minutes.

7. The method of claim 1, wherein the aluminum surface is immersed in the aqueous fluid.

8. The method of claim 7, further comprising:
agitating the aqueous fluid while the aluminum surface is immersed in the aqueous fluid.

9. The method of claim 1, wherein the aqueous fluid is gaseous and is directed at the aluminum surface.

10. The method of claim 1, further comprising:
applying a coating to the aluminum surface.

11. The method of claim 1, wherein the aqueous fluid comprises an additive selected from the group consisting of a surfactant, an electrolyte, a cosolvent, a buffer and combinations thereof.

12. The method of claim 8, wherein the aqueous fluid comprises a surfactant and agitating the aqueous fluid comprises applying ultrasonic vibration to the aqueous fluid.

13. The method of claim 12, wherein the aqueous fluid is at a temperature between about 20° C. and about 90° C., and wherein ultrasonic vibration is applied to the aqueous fluid with a power density between about 2.6 watts per liter and about 26.4 watts per liter at a frequency between about 15 kHz and about 400 kHz for between about five minutes and about thirty minutes.

14. The method of claim 11, wherein the aqueous fluid comprises an electrolyte, and wherein the aluminum article is immersed in the fluid, and wherein removing residual flux and metal oxides further comprises:
applying an electric current to the aqueous fluid and the aluminum article.

15. The method of claim 14, wherein the aluminum article serves as a cathode.

16. The method of claim 15, wherein the removal step further comprises:
applying a reverse anodic current to the aluminum article to remove positively-charged particles.

17. The method of claim 14, wherein the electric current is applied for between about thirty seconds and about five minutes.

18. The method of claim 14, wherein the electric current is applied at a current density between about 50 amperes per square meter and about 165 amperes per square meter to create an electric field having a voltage of between about six volts and about twelve volts.

19. The method of claim 14, wherein the fluid temperature is between about 50° C. and about 80° C.

20. The method of claim 1, wherein application of the aqueous fluid to the aluminum surface is selected from the group consisting of water bath immersion, water spraying, steam spraying, and combinations thereof.
